(19) United States
(12) Patent Application Publication
(10) Pub. No.: US 2014/0203748 A1
(43) Pub. Date: Jul. 24, 2014

(54) MOTOR CONTROL DEVICE AND MOTOR CONTROL METHOD

(71) Applicant: MINEBEA CO., LTD., KITASAKU-GUN (JP)

(72) Inventors: Kazuo TAKADA, KOSAI-SHI (JP); Takayuki MATSUI, TOYOHASHI-SHI (JP); Scott JACOBS, NOVI, MI (US)

(73) Assignee: MINEBEA CO., LTD., KITASAKU-GUN (JP)

(21) Appl. No.: 14/088,641

(22) Filed: Nov. 25, 2013

(30) Foreign Application Priority Data
Jan. 22, 2013 (JP) 2013-008962

(51) Int. Cl. H02P 29/00

(52) U.S. Cl. CPC H02P 29/005
USPC 318/473

(57) ABSTRACT

There is provided a motor control device for an actuator having a motor, including a measuring unit configured to measure a temperature of the actuator or a temperature corresponding to the temperature of the actuator, a determining unit configured to determine whether the temperature measured by the measuring unit is lower than a preset temperature, and a boost control unit configured to perform boost control at activation of the motor to increase drive power supplied to the motor if the determining unit determines that the temperature measured by the measuring unit is lower than the preset temperature. The boost control unit is configured to perform the boost control such that, only within a boost period after starting activation of the motor, drive power larger than that supplied to the motor during steady driving after the boost period is supplied to the motor.

### BACKGROUND OF THE INVENTION

1. Field of the Invention

The present invention relates to a motor control device and a motor control method, and particularly, to a motor control device and a motor control method for an actuator which can be used even under a low temperature environment.

2. Description of the Related Art

Some actuator using a motor such as a stepping motor, for example, an actuator for on-vehicle use, is used under a low temperature environment such as a low temperature place. If an actuator is used under a low temperature environment, a drive unit of the actuator may freeze, or a lubricant applied on the drive unit may harden. In a case of activating the actuator in that state, even if it is tried to operate a motor for driving the actuator with torque necessary during steady operation (a state where a normal operation is performed after activation of the actuator is completed under a low temperature environment), the motor may be not able to activate the actuator.

In view of this problem, in order to surely operate the actuator even under a low temperature environment, during entire driving, drive power larger than that necessary during the steady operation is supplied to the motor, such that the motor is driven with high torque.

Also, in relation to this problem, JP-A-H5-76190 discloses an AC motor activating device configured to apply a boost voltage according to an ambient temperature at activation of a motor.

This device is configured to be able to automatically set the boost voltage necessary for activating the motor to an appropriate value by self-learning.

### SUMMARY OF THE INVENTION

However, in the method of always supplying the large drive power to the motor as described above, there may be a problem. That is, the high torque capable of rotating the motor in a frozen state or rotating the motor against a hard lubricant is necessary only at activation of the motor. If the actuator is activated once, that high torque would become unnecessary, and the motor can be driven even with the torque necessary during the steady operation to maintain an operating state of the actuator. In this case, in order to always drive the motor with torque higher than that (originally necessary torque) necessary to maintain the steady operation (normal operation) state, excessive drive power is always supplied, so that power consumption of the motor increases. Further, in a case where an upper limit is set to the torque of the motor according to the use or the like of the actuator, there may be a problem that it is not allowed to always operate the motor with excessive torque which would exceed the upper limit.

In the meantime, if the device disclosed in JP-A-H5-76190 fails in activation of the motor, after a predetermined time, the device repeatedly re-activates the motor by a boost voltage higher than a previous voltage by a predetermined voltage, thereby applying the boost voltage necessary for activating the motor. That is, in this device, a control circuit feeds back the failure of the activation, and optimizes the boost voltage. Therefore, there is a possibility that the device might fail in activation of the motor several times.

The present invention has been made in view of the above circumstances, and an object of the present invention is to provide a motor control device and a motor control method capable of surely activating a motor even under a low temperature environment and also suppressing power consumption.

According to an illustrative embodiment of the present invention, there is provided a motor control device used for an actuator using a motor and is configured to drive the motor. The motor control device includes a measuring unit configured to measure a temperature of the actuator or a temperature corresponding to the temperature of the actuator, a determining unit configured to determine whether the temperature measured by the measuring unit is lower than a preset temperature, and a boost control unit configured to perform boost control at activation of the motor to increase drive power supplied to the motor if the determining unit determines that the temperature measured by the measuring unit is lower than the preset temperature. The boost control unit is configured to perform the boost control such that, only within a boost period after starting activation of the motor, drive power larger than that supplied to the motor during steady driving after the boost period is supplied to the motor.

In the above motor control device, the boost control unit may be configured to change the boost period according to the temperature measured by the measuring unit.

In the above motor control device, the boost control unit may be configured to perform the boost control such that the drive power larger than that during the steady driving by a predetermined ratio is supplied to the motor.

In the above motor control device, the boost control unit may be configured to perform the boost control such that the drive power larger than that during the steady driving by a ratio according to the temperature measured by the measuring unit is supplied to the motor.

In the motor control device, the boost control unit may be configured to perform the boost control such that the drive power supplied to the motor in the boost period is decreased over time.

In the motor control device, the measuring unit may be configured to measure an internal temperature of a control circuit of the motor control device.

According to another illustrative embodiment of the present invention, there is provided a control method of a motor control device used for an actuator using a motor and is configured to drive the motor. The control method includes measuring a temperature of the actuator or a temperature corresponding to the temperature of the actuator, determining whether the measured temperature is lower than a preset temperature, and performing boost control at activation of the motor to increase drive power supplied to the motor if it is determined that the measured temperature is lower than the preset temperature. The boost control is performed such that only within a boost period after starting activation of the motor, drive power larger than that supplied to the motor during steady driving after the boost period is supplied to the motor.

According to the above configuration, if the measured temperature is low, the boost control is performed such that, only within the boost period after starting activation of the motor, the drive power larger than that during the steady driving is supplied to the motor. Therefore, it is possible to provide a motor control device and a motor control method capable of surely activating a motor even under a low temperature environment and also suppressing power consumption.

### BRIEF DESCRIPTION OF THE DRAWINGS

In the accompanying drawings:

FIG. 1 is an exploded perspective view showing an example of an actuator using a motor control device according to an illustrative embodiment of the present invention;

FIG. 2 is a block diagram showing a motor and the motor control device configuring an actuator according to an illustrative embodiment of the present invention;

FIG. 3 is a view schematically showing a circuit configuration of a stepping motor;

FIG. 4 is a flow chart explaining a process of driving the stepping motor which the motor control device performs;

FIG. 5 is a graph showing drive power over time when the stepping motor is activated in an activation mode under a low temperature; and

FIG. 6 is a graph showing drive power over time when the stepping motor is activated in a modified activation mode under a low temperature.

### DETAILED DESCRIPTION

Hereinafter, a motor control device according to an illustrative embodiment of the present invention will be described.

The motor control device is, for example, configured to drive a stepping motor having multiple phase coils. The motor control device controls an energizing state of a coil of each phase for driving the stepping motor. In the present illustrative embodiment, the motor control device includes a drive circuit for energizing the coils of the stepping motor, and a control circuit for controlling the drive circuit.

The motor control device, the stepping motor driven by the motor control device, and other mechanism elements configure an actuator. In the actuator, the stepping motor is driven by drive power supplied from the drive circuit. In the actuator, the drive circuit is controlled by the control circuit, so that the driving of the stepping motor is controlled.

### Illustrative Embodiment

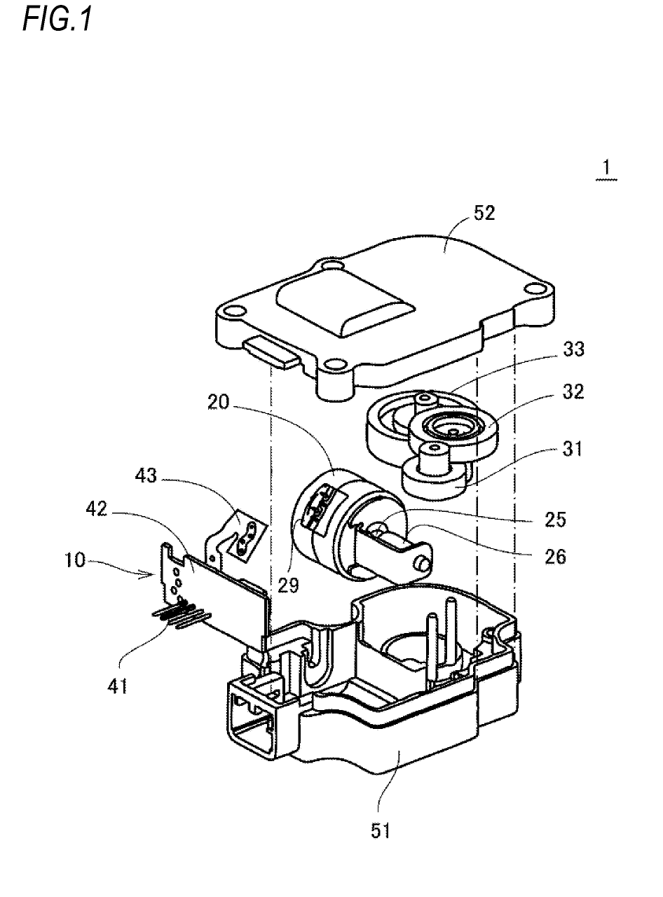

FIG. 1 is an exploded perspective view showing an example of an actuator using a motor control device according to the present illustrative embodiment.

As shown in FIG. 1, an actuator 1 is covered by a case 51 and a cover 52. The actuator 1 accommodates therein a motor control device 10, a stepping motor 20, a secondary gear 31, a tertiary gear 32, an output gear 33, and the like. An external output gear of the output gear 33 is exposed from a bottom of the case 51, such that a driving force of the actuator 1 is transmitted to the outside by the external output gear.

The stepping motor 20 generates the driving force of the actuator 1. A primary gear 26 is fit on an output shaft 25 of the stepping motor 20. The primary gear 26 of the stepping motor 20 is engaged with the secondary gear 31. The secondary gear 31 is engaged with the tertiary gear 32. The tertiary gear 32 is engaged with the output gear 33.

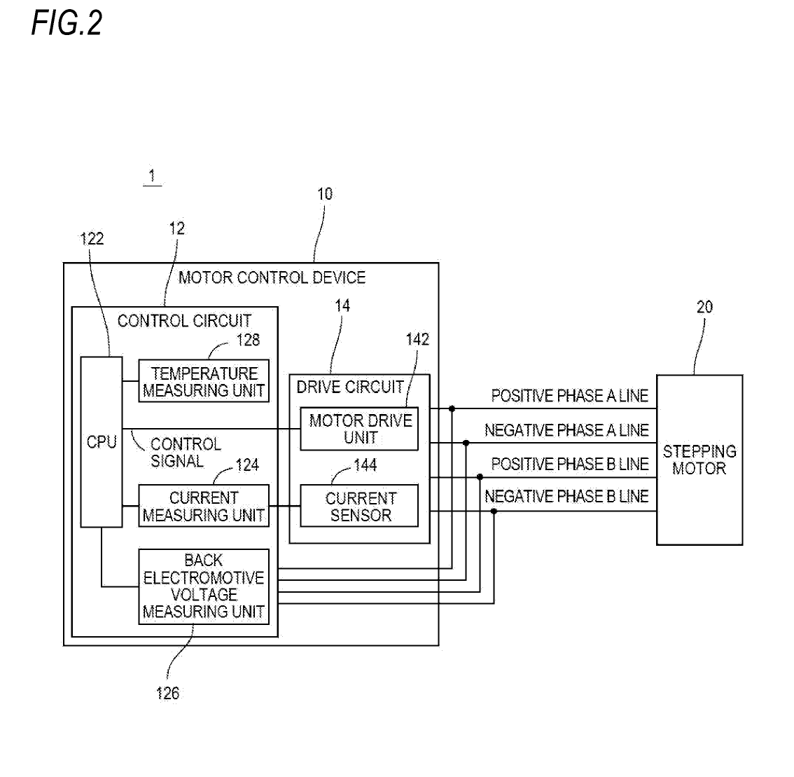

The motor control device 10 includes a printed circuit board 42, a flexible printed circuit board 43 for connecting the printed circuit board 42 and a motor terminal 29 of the stepping motor 20, and the like. A drive circuit 14 (shown in FIG. 2) for driving the stepping motor 20, a control circuit 12 (shown in FIG. 2) for controlling the drive circuit 14, and the like are provided on the printed circuit board 42. An external connection terminal 41 is provided on the printed circuit board 42 exposed to the outside of the case 51 and the cover 52. Electric power is supplied from the outside or an instruction signal is received from an external device, through the external connection terminal 41, such that the motor control device 10 operates.

The motor control device 10 supplies drive power to the stepping motor 20, thereby driving the stepping motor 20. When the stepping motor 20 is driven, the primary gear 26 rotates together with the output shaft 25. The driving force of this rotation is sequentially transmitted to the secondary gear 31, the tertiary gear 32, the output gear 33, and the external output gear, and is output to the outside by the external output gear.

Incidentally, in the present illustrative embodiment, the stepping motor 20 is provided as a driving source of the actuator 1. However, the present invention is not limited thereto. Any other kind of motor may be used. Also, a circuit accommodated in the case 51 and the cover 52 may be, for example, only the drive circuit 14. In this case, the motor control device 10 may be configured by the drive circuit 14 provided inside of the case 51 and the cover 52, and an external control circuit 12 connected to the drive circuit 14.

FIG. 2 is a block diagram showing the motor and the motor control device configuring the actuator according to the present illustrative embodiment of the present invention.

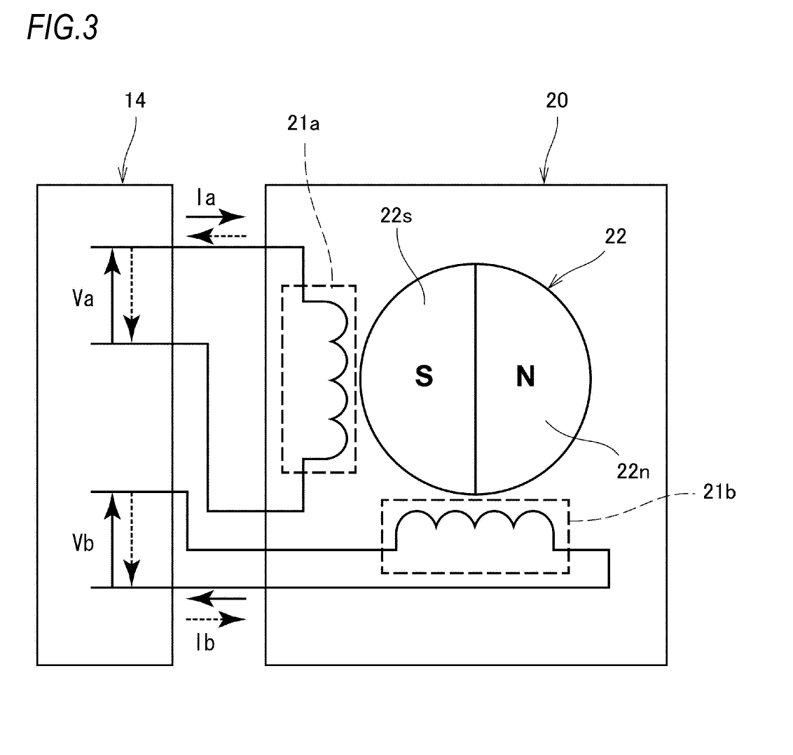

As shown in FIG. 2, the actuator 1 includes the motor control device 10, the stepping motor 20, a gear box (not shown), and a casing (not shown) for accommodating them. The stepping motor 20 is driven, for example, by two-phase excitation of phase A and phase B. The stepping motor 20 includes a coil of the phase A and a coil of the phase B (shown in FIG. 3). Electric power is supplied from the motor control device 10 to the coils of each phase, whereby the stepping motor 20 is driven. The stepping motor 20 is used, for example, as an actuator for an air conditioner mounted in a vehicle. Incidentally, the usage of the stepping motor 20 and the actuator 1 are not limited thereto.

The motor control device 10 includes the control circuit 12 and the drive circuit 14.

The drive circuit 14 includes a motor drive unit 142 and a current sensor 144. The drive circuit 14 supplies drive power to the stepping motor 20, thereby driving the stepping motor 20.

The control circuit 12 includes a CPU (central processing unit) (an example of a determining unit and an example of a boost control unit) 122, a current measuring unit 124, a back electromotive voltage measuring unit 126, and a temperature measuring unit (an example of a measuring unit) 128. The control circuit 12 controls the drive circuit 14 to control driving of the stepping motor 20. In the present illustrative embodiment, the control circuit 12 is packaged as an IC (integrated circuit).

The motor drive unit 142 is a module for applying voltage to the coil of the each phase of the stepping motor 20. The motor drive unit 142 receives a control signal from the CPU 122. The motor drive unit 142 applies the voltage based on the control signal. In the present illustrative embodiment, the drive circuit 14 and the stepping motor 20 are connected by four lines, that is, a positive phase A line, a negative phase A line, a positive phase B line, and a negative phase B line. The motor drive unit 142 supplies electric power to the stepping motor 20 through those lines based on the control signal.

The current sensor 144 is a module for sensing current (a coil current) flowing in the coil of the each phase of the stepping motor 20. The current sensor 144 outputs the sensing result of the coil current to the current measuring unit 124.

The current measuring unit 124 is a module for measuring the coil current of the stepping motor 20. The current measuring unit 124 receives the sensing result of the coil current output from the current sensor 144. The current measuring unit 124 measures the coil current based on the received sensing result. The current measuring unit 124 outputs the measuring result of the coil current to the CPU 122.

The back electromotive voltage measuring unit 126 is a module for measuring a back electromotive voltage induced in the coil of the each phase of the stepping motor 20. In the present illustrative embodiment, the back electromotive voltage measuring unit 126 is connected to each of the four lines connecting the drive circuit 14 and the stepping motor 20. The back electromotive voltage measuring unit 126 outputs the measuring result of the back electromotive voltage to the CPU 122.

The temperature measuring unit 128 is, for example, a temperature sensor for measuring an internal temperature of the IC of the control circuit 12. The temperature measuring unit 128 outputs temperature information representing the temperature of the control circuit 12 to the CPU 122.

The CPU 122 receives the measuring result of the coil current output from the current measuring unit 124, the measuring result of the back electromotive voltage output from the back electromotive voltage measuring unit 126, and the temperature information output from the temperature measuring unit 128. The CPU 122 generates the control signal for controlling a voltage applied to the stepping motor 20. The CPU 122 generates the control signal based on the measuring result of the coil current when driving the stepping motor 20. The CPU 122 outputs the generated control signal to the motor drive unit 142.

FIG. 3 is a view schematically showing a circuit configuration of the stepping motor 20.

As shown in FIG. 3, the stepping motor 20 includes two coils 21a and 21b, a rotor 22, and a plurality of stator yokes (not shown).

Each of the coils 21a and 21b is a coil for exciting the stator yokes. Each of the coils 21a and 21b is connected to the drive circuit 14. The coil 21a is the coil of the phase A. The coil 21b is the coil of the phase B. In the coils 21a and 21b, coil currents of different phases flow, respectively.

The rotor 22 includes a multi-pole permanent magnet magnetized such that a south pole 22s and a north pole 22n are alternately reversed. Also, in FIG. 3, the rotor 22 is simply shown to include one south pole 22s and one north pole 22n. The stator yokes are disposed around the rotor 22 close to the periphery of the rotor 22. The phases of the coil currents flowing in the coils 21a and 21b are periodically switched, whereby the rotor 22 rotates.

In the present illustrative embodiment, when the stepping motor 20 is driven, the CPU 122 and the motor drive unit 142 apply a pulse voltage subjected to pulse width modulation to each of the coils 21a and 21b.

The stepping motor 20 is driven as follows. That is, a pulse voltage (a coil voltage Vₐ) is applied to the coil 21a such that the polarity of a coil current Iₐ (that is, the direction of the coil current Iₐ) varies in a predetermined cycle. Meanwhile, a pulse voltage (a coil voltage V_{b}) is applied to the coil 21b in the same cycle as that of the coil 21a. The pulse voltage is applied to the coil 21b such that the polarity of a coil current I_{b} (that is, the direction of the coil current I_{b}) varies later than the coil current Iₐ by a predetermined phase.

If the coil currents Iₐ and I_{b} flow in the coils 21a and 21b, respectively, the stator yokes of the coils 21a and 21b are excited according to the polarities of the coil currents Iₐ and I_{b}. As a result, the rotor 22 rotates in a predetermined step unit.

Here, in the present illustrative embodiment, the motor control device 10 performs control based on the temperature measured by the temperature measuring unit 128 at activation of the stepping motor 20. This control will be described below.

At activation of the stepping motor 20, when the actuator 1 is under a low temperature environment, the motor control device 10 performs boost control such that, only within a predetermined boost period from start of driving of the stepping motor 20, the drive power of the stepping motor 20 is increased by a predetermined amount. That is, when the actuator 1 is under a low temperature environment, the motor control device 10 boosts the drive power of the stepping motor 20 only within the predetermined period from start of the driving.

In the present illustrative embodiment, the CPU 122 determines whether the actuator 1 is under a low temperature environment based on the temperature measured by the temperature measuring unit 128 of the inside of the control circuit 12. That is, if the motor control device 10 is under a low temperature environment, the CPU 122 performs the above described boost control on the drive power.

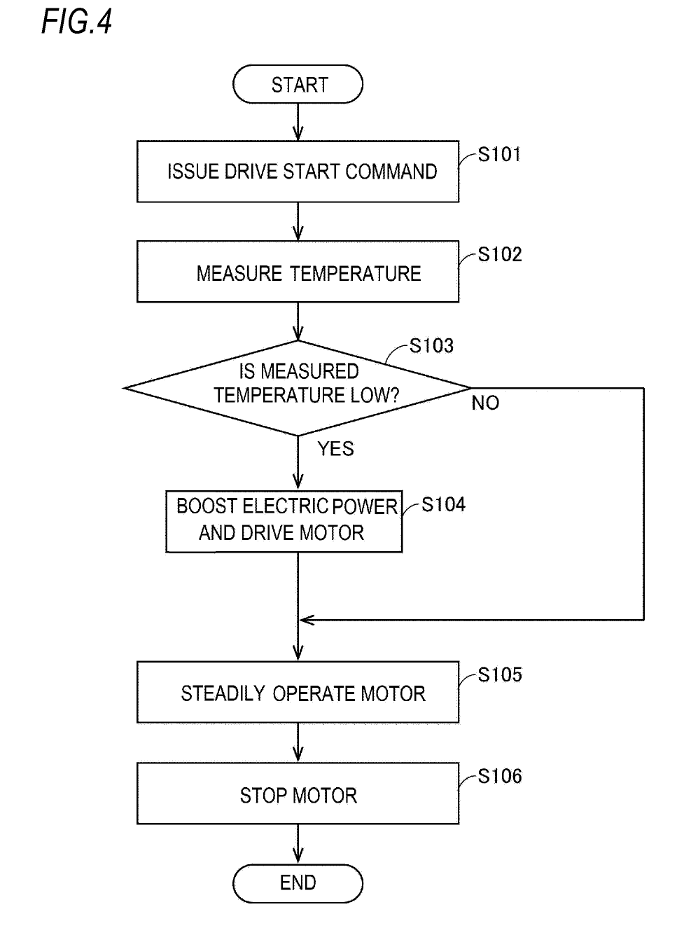

FIG. 4 is a flow chart explaining a process of driving the stepping motor 20 which the motor control device 10 performs.

Referring to FIG. 4, in a Step S101, the CPU 122 issues a drive start command of the stepping motor 20. The drive start command is issued in a state where driving of the stepping motor 20 is stopped.

In a Step S102, the CPU 122 acquires a result of temperature measurement of the temperature measuring unit 128.

In a Step S103, the CPU 122 determines whether the temperature measured by the temperature measuring unit 128 is low. This determination is performed, for example, by comparing the measured temperature with a preset temperature (a threshold value). If the measured temperature is lower than the preset temperature, the CPU 122 determines that the measured temperature is low.

If it is determined in the Step S103 that the measured temperature is not low, a Step S104 is skipped, and in a Step S105, the CPU 122 drives the stepping motor 20 in a steady operation mode (steady driving). Here, the steady operation mode refers to a mode of activating the stepping motor 20 by applying drive power same as the driving power during the steady operation after completion of activation, to the stepping motor 20.

Meanwhile, if it is determined in the Step S103 that the measured temperature is low, in the Step S104, the CPU 122 drives the stepping motor 20 in an activation mode under a low temperature (under a low temperature environment). Here, the activation mode under a low temperature refers to a mode of activating the stepping motor 20 while boosting the driving power (boosting power, for example, boosting current) (boost control). In the present illustrative embodiment, the boost control is performed such that, only within a boost period after starting activation of the stepping motor 20, the boosted drive power is supplied to the stepping motor 20. That is, the stepping motor 20 is activated by supplying drive power larger than that supplied at the steady operation after end of the boost period (after completion of activation) by a predetermined ratio to the stepping motor 20 based on the control of the CPU 122, such that the stepping motor 20 is activated.

If the motor is activated in the Step S104, in the Step S105, the CPU 122 steadily operates the stepping motor 20. For example, if it is determined in the Step S103 that the measured temperature is low, in the Step S104, activation of the stepping motor 20 starts. Thereafter, if the boost period ends, the process of the Step S105 is performed.

In a Step S106, the CPU 122 stops the stepping motor 20 in cases where a predetermined condition is satisfied, where supply of electric power to the motor control device 10 ends, or the like. Further, for example, the operation of the stepping motor 20 is stopped in cases where a control signal for stopping the stepping motor 20 is input from an external device to the control circuit 12, where a predetermined time has elapsed from activation, where the stepping motor 20 has rotated by a predetermined number of steps, or the like. However, present invention is not limited thereto.

If the stepping motor 20 is stopped in the Step S106, the series of control ends.

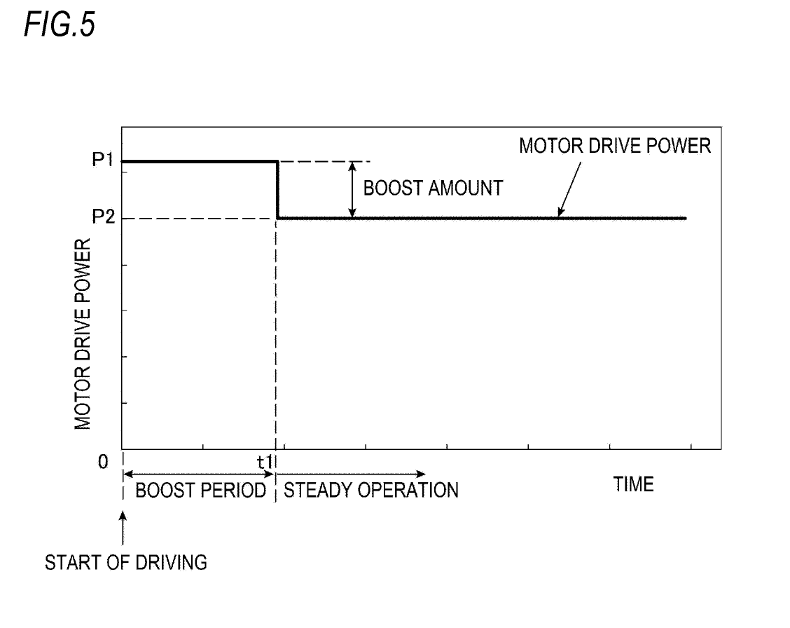

FIG. 5 is a graph showing the drive power over time when the stepping motor 20 is activated in the activation mode under a low temperature.

In FIG. 5, the boost period and the steady operation (steady driving) period are divided by a time point t1 from start of activation. At the steady driving, the drive power of the stepping motor 20 is set to P2. Meanwhile, in the boost period from when activation starts to when the boost period ends, the drive power is set to P1 larger than P2. That is, in the boost period, the stepping motor 20 is driven while the drive power is boosted by the boost amount (P1-P2).

Here, in the present illustrative embodiment, the boosting of the power is performed, for example, when the internal temperature of the IC is equal to or lower than T° C. The threshold value “T” is appropriately set within a range from −5° C. to +15° C., for example, according to the configuration of the actuator 1. For example, in a case where the threshold value T is set to −5° C., when the internal temperature of the IC is equal to or lower than −5° C., the CPU 122 activates the stepping motor 20 while boosting the drive power. Incidentally, a range of values which can be set as the threshold value T is not limited thereto.

In the present illustrative embodiment, when the boosting of the power is performed in the activation mode under a low temperature, current boosting may be performed. However, the present invention is not limited thereto. As the boosting of the power, voltage boosting may be performed by a voltage booster circuit or the like, or both of current and voltage may be boosted.

A specific example of boosting the current will be described. When activating the stepping motor 20 in the activation mode under a low temperature, a predetermined drive current is applied only during a predetermined boost period, for example, as follows.

That is, when boosting the current, the drive current is controlled so as to be larger than a drive current during the steady operation by 10% to 30%. For example, when a motor drive current during the steady operation is 100 mA, in the period when boosting the current, the CPU 122 performs control such that the drive current falls in a range from 110 mA to 130 mA.

The boost period to apply the drive current larger than that during the steady driving by boosting the current is controlled to be a period from when driving starts to when 50 msec to 300 msec elapses. In other words, the boost period is set in a range from start of driving to 50 msec to 300 msec.

With respect to this boosting of the current, the boost amount and the range of the boost period were set based on experimental results. For example, when the actuator 1 was under a low temperature environment of −40° C., when control was performed so as to apply a drive current boosted by a boost amount of 17% to the stepping motor 20 for 96 msec, the actuator 1 could be successfully activated.

The boost amount and the range of the boost period are not limited to the case of boosting only current, but can be applied even to a case of boosting voltage. That is, when boosting the power, the boost amount of the drive power may be set in a range from 10% to 30% of the drive power during the steady driving. Also, the boost period may be set to a range from when driving starts to when 50 msec to 300 msec elapses.

As described above, in the present illustrative embodiment, even under a low temperature environment where it fails to activate the stepping motor 20 with the driving power during the steady driving, since the boost control is performed at activation, the stepping motor 20 can be surely activated. Since the boost control is performed only in the predetermined boost period, if the boost period ends, the stepping motor 20 is driven with the drive power during the steady operation (steady driving). Therefore, as compared to a case of employing the related-art method of always driving with drive power larger than that during the steady operation, the power consumption of the actuator 1 can be reduced. Also, even when a limit is set to output torque of the actuator 1, since driving with large drive power is performed only at start of driving of the stepping motor 20, the actuator 1 can be surely activated while keeping the torque within the limit during the steady operation.

The boost control is performed such that the drive power supplied to the stepping motor 20 is increased to be larger than that during the steady driving by a predetermined ratio. Therefore, under a low temperature environment, drive power appropriately large to activate the stepping motor 20 is supplied to the stepping motor 20. Therefore, the stepping motor 20 can be surely activated without consuming excessive power.

Also, the temperature measurement for determining whether the actuator 1 is under a low temperature environment is performed by the temperature measuring unit 128 of the inside of the control circuit 12. Therefore, it is unnecessary to provide a new temperature sensor or the like for determining whether to perform the boost control as described above. Therefore, the configuration of the motor control device 10 can be simplified, and the manufacturing cost of the motor control device 10 can be reduced.

[Modifications]

The CPU 122 may change the boost period according to the internal temperature of the control circuit 12 measured by the temperature measuring unit 128 and then perform the boost control. For example, the CPU 122 may set the boost period longer as the measured temperature lowers, and then perform the boost control. In this case, the time range settable as the boost period may be determined in advance. For example, the boost period may be set in a range from when driving starts to when 50 msec to 300 msec elapses, according to the temperature. Also, the boost period may be set according to the difference between the measured temperature and the threshold value.

Also, the CPU 122 may perform the boost control such that the drive power larger than that during the steady driving by a ratio according to the temperature measured by the temperature measuring unit 128 is supplied to the stepping motor 20. For example, the CPU 122 may perform control in the boost period such that the boost amount of the drive power supplied to the stepping motor 20 increases as the measured temperature lowers. In this case, the range of the drive power increased with respect to the drive current during the steady driving may be determined in advance. For example, the ratio for boosting of the power may be set in a range from 10% to 30% according to the temperature. Also, the CPU 122 may change both the boost period and the ratio for boosting the power, according to the measured temperature.

If the boost period, the ratio for boosting the power, or the like may be changed according to the measured temperature as described above, necessary drive power can be supplied to the stepping motor 20 according to situations under low temperature environments. Therefore, the stepping motor 20 can be more surely activated while reducing power consumption.

Also, the CPU 122 may perform the boost control in the boost period such that the drive power supplied to the stepping motor 20 is decreased over time.

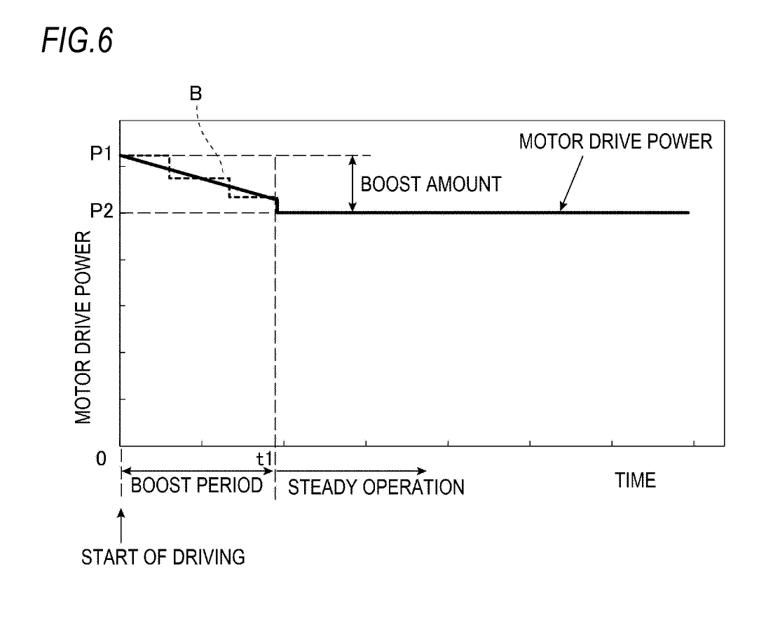

FIG. 6 is a graph showing the drive power over time when the stepping motor 20 is activated according to a modified activation mode under a low temperature.

For example, as shown in FIG. 6, when activation of the stepping motor 20 starts, the activation may start by the drive power P1 larger than the drive power P2 during the steady driving (steady operation) by a predetermined ratio, and thereafter, in the boost period t1, the drive power may be gradually decreased over time. Also, as shown by a broken line B in FIG. 6, the boost control may be performed in the boost period t1 such that the drive power changes in a stepwise manner over time.

### OTHERS

Only a portion of the control circuit may be configured as an integrated circuit. Also, a portion of a part of the motor control device different from the control circuit may be configured as an integrated circuit. The whole of the motor control device may be configured as an integrated circuit.

A hardware configuration of the actuator such as the stepping motor and the motor control device is not limited to the above described configuration.

The above described processes according to the illustrative embodiment may be performed by software, or may be performed by a hardware circuit.

It is also possible to provide a program for performing the above-described processes according to the illustrative embodiment, and the corresponding program may be recorded in recording media such as a CD-ROM, a flexible disk, a hard disk, a ROM, a RAM, and a memory card to provide to users. The corresponding program may be downloaded to an apparatus through a communication line such as the Internet. The processes described in sentences in the above described flow charts may be performed according to the corresponding program by the CPU or the like.

It should be understood that the illustrative embodiment disclosed herein is illustrative and non-restrictive in every respect. The scope of the present invention is defined by the terms of the claims, rather than the description above, and is intended to include any modifications within the scope and meaning equivalent to the terms of the claims.

What is claimed is:

1. A motor control device used for an actuator using a motor and is configured to drive the motor, the motor control device comprising:
a measuring unit configured to measure a temperature of the actuator or a temperature corresponding to the temperature of the actuator;
a determining unit configured to determine whether the temperature measured by the measuring unit is lower than a preset temperature; and
a boost control unit configured to perform boost control at activation of the motor to increase drive power supplied to the motor if the determining unit determines that the temperature measured by the measuring unit is lower than the preset temperature,
wherein the boost control unit is configured to perform the boost control such that, only within a boost period after starting activation of the motor, drive power larger than that supplied to the motor during steady driving after the boost period is supplied to the motor.

2. The motor control device according to claim 1,
wherein the boost control unit is configured to change the boost period according to the temperature measured by the measuring unit.

3. The motor control device according to claim 1,
wherein the boost control unit is configured to perform the boost control such that the drive power larger than that during the steady driving by a predetermined ratio is supplied to the motor.

4. The motor control device according to claim 1,
wherein the boost control unit is configured to perform the boost control such that the drive power larger than that during the steady driving by a ratio according to the temperature measured by the measuring unit is supplied to the motor.

5. The motor control device according to claim 1,
wherein the boost control unit is configured to perform the boost control such that the drive power supplied to the motor in the boost period is decreased over time.

6. The motor control device according to claim 1,
wherein the measuring unit is configured to measure an internal temperature of a control circuit of the motor control device.

7. A control method of a motor control device used for an actuator using a motor and is configured to drive the motor, the control method comprising:
measuring a temperature of the actuator or a temperature corresponding to the temperature of the actuator;
determining whether the measured temperature is lower than a preset temperature; and
performing boost control at activation of the motor to increase drive power supplied to the motor if it is determined that the measured temperature is lower than the preset temperature,
wherein the boost control is performed such that only within a boost period after starting activation of the motor, drive power larger than that supplied to the motor during steady driving after the boost period is supplied to the motor.
